(19) United States
(12) Patent Application Publication
(10) Pub. No.: US 2005/0241058 A1
(43) Pub. Date: Nov. 3, 2005

(54) Hot water steam sauna-shower device

(76) Inventor: Zhan Kai Li, Zhongshan (CN)

Correspondence Address: FORTUNE LAW GROUP LLP, 100 CENTURY CENTER COURT, SUITE 315, SAN JOSE, CA, 95112, US

(21) Appl. No.: 10/412,661

(22) Filed: Apr. 11, 2003

(51) Int. Cl. A61H 33/06

(52) U.S. Cl. 4/525

(57) ABSTRACT

A hot water steam sauna-shower device includes a body fed by a hot water supply line, a plurality of nozzles disposed on the body in communication with the hot water supply line, a shower head disposed on the body in communication with the hot water supply line, and a valve for diverting the hot water from the plurality of nozzles to the shower head.

### BACKGROUND OF THE INVENTION

This invention relates generally to sauna-shower devices and more particularly to a hot water steam sauna-shower device for generating steam at a side and bottom portion of an enclosed room.

Combination sauna-shower devices are well known in the art. For example an atomized bath is disclosed in U.S. Pat. No. 6,500,197 to Buesselmann including an atomizer having a hollow cylindrical compression space having an aperture. Compression space is in communication via a line with a high-pressure pump from which the liquid to be atomized is delivered.

U.S. Pat. No. 5,142,713 to Makool discloses an adapter for selectively converting a conventional shower to a steam sauna. The adapter includes a spray mist nozzle means for developing a spray mist in a prescribed fan or broom pattern.

As can be seen, there is a need for a hot water steam sauna-shower device for generating steam at a side and bottom portion of an enclosed room. Preferably such a hot water steam sauna-shower device utilizes an existing hot water source to the enclosed room. Further such a hot water steam sauna-shower device does not require a pump or other energy consuming and space consuming steam generator thereby reducing its cost.

### SUMMARY OF THE INVENTION

In accordance with the present invention, a hot water steam sauna-shower device includes a body fed by a hot water supply line, a plurality of nozzles disposed on the body in communication with the hot water supply line, a shower head disposed on the body in communication with the hot water supply line, and a valve for diverting the hot water from the plurality of nozzles to the shower head.

In accordance with yet another embodiment of the invention, a hot water steam sauna-shower room includes an enclosed room, a body disposed inside the enclosed room and fed by a hot water supply line, a plurality of nozzles disposed on the body in communication with the hot water supply line, a shower head disposed on the body in communication with the hot water supply line, and a valve for diverting the hot water from the plurality of nozzles to the shower head.

These and other features, aspects and advantages of the present invention will become better understood with reference to the following drawings, description and claims.

### BRIEF DESCRIPTION OF THE DRAWINGS

FIG. 1 is a perspective view of an enclosed room including a hot water steam sauna-shower device in accordance with the invention.

### DETAILED DESCRIPTION OF THE INVENTION

In the following detailed description of the present invention, numerous specific details are set forth in order to provide a thorough understanding of the present invention. However, it will become obvious to those skilled in the art that the present invention may be practiced without these specific details. In other instances, well known methods, procedures, components, and circuitry have not been described in detail to avoid unnecessarily obscuring aspects of the present invention.

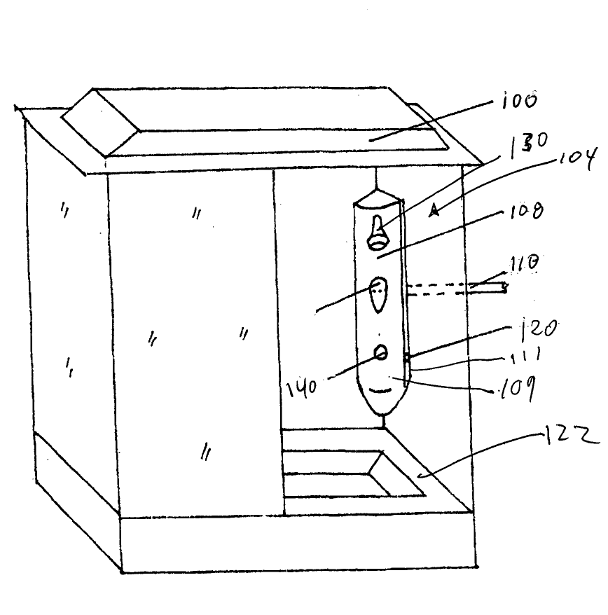

With reference to FIG. 1, an enclosed room 100 is shown including a hot water steam sauna-shower device generally designated 104. Enclosed room 100 preferably has a volume of 4 cubic meters.

The device 104 is shown disposed in a corner of enclosed room 100. The device 104 includes a body 108 fed by a water supply line 110. The body may be attached to the enclosed room 100 or hung therein. The water supply line 110 preferably provides 45 to 85 degree centigrade water at from 0.2 to 0.65 mPa pressure.

Body 108 may include a plurality of nozzles 120 in communication with the water supply line 110 and disposed on a bottom portion 109 thereof. In a preferred embodiment of the invention, the nozzles 120 are disposed on a side portion 111 of the body 108. In use the nozzles 120 are preferably disposed at about 0.5 m from a bottom 122 of the enclosed room 100. Nozzles 120 preferably include a plurality of orifices (not shown) having diameters from 0.1 to 0.3 mm.

Body 108 further includes a shower head 130 in communication with the water supply line 110 and a valve 140 for diverting water from the nozzles 120 to the shower head 130.

In use, the valve 140 may be positioned so as to divert the hot water from water supply line 110 to the plurality of nozzles 120. The orifices in the nozzles 120 are operable to break the pressurized hot water into steam droplets having diameters of less than 0.3 mm. The steam droplets fill the enclosed room 100 to thereby create the steam effect that a sauna room requires increasing the room temperature to over 65 degrees centigrade within 2 to 3 minutes. Valve 140 may alternatively be positioned to divert the water to the shower head 130.

As illustrated and described, the hot water steam sauna-shower device generates steam at a side and bottom portion of an enclosed room. Those skilled in the art will appreciate that the preferred embodiments can be easily adapted and modified to suit additional applications without departing from the spirit, and scope of this invention. Thus, it is to be understood that the scope of the invention is not limited to the disclosed embodiments. On the contrary, it is intended to cover various modifications and similar arrangements based upon the same operating principles. The scope of the claims, therefore, should be accorded the broadest interpretations so as to encompass all such modifications and similar arrangements.

1. A hot water steam sauna-shower device comprising:
a body fed by a hot water supply line;
a plurality of nozzles disposed on the body in communication with the hot water supply line;
a shower head disposed on the body in communication with the hot water supply line; and
a valve for diverting the hot water from the plurality of nozzles to the shower head.

2. The hot water steam sauna-shower device of claim 1, wherein the water supply line from provides 45 to 85 degree centigrade water at from 0.2 to 0.65 mPa pressure.

3. The hot water steam sauna-shower device of claim 1, wherein the nozzles comprise a plurality of orifices having diameters from 0.1 to 0.3 mm.

4. The hot water steam sauna-shower device of claim 1, wherein the nozzles are disposed on a bottom portion of the body.

5. A hot water steam sauna-shower room comprising:
an enclosed room;
a body disposed inside the enclosed room and fed by a hot water supply line;
a plurality of nozzles disposed on the body in communication with the hot water supply line;
a shower head disposed on the body in communication with the hot water supply line; and
a valve for diverting the hot water from the plurality of nozzles to the shower head.

6. The hot water steam sauna-shower room of claim 5, wherein the water supply line provides from 45 to 85 degree centigrade water at from 0.2 to 0.65 mPa pressure.

7. The hot water steam sauna-shower room of claim 5, wherein the nozzles comprise a plurality of orifices having diameters from 0.1 to 0.3 mm.

8. The hot water steam sauna-shower room of claim 5, wherein the nozzles are disposed 0.5 m from a bottom of the enclosed room.
